(19) United States
(12) Patent Application Publication
(10) Pub. No.: US 2025/0043619 A1
(43) Pub. Date: Feb. 6, 2025

(54) FLUIDIC DEVICE FOR REGULATING LIGHT TRANSMISSION THROUGH THE DEVICE

(71) Applicant: THE GOVERNING COUNCIL OF THE UNIVERSITY OF TORONTO, Toronto (CA)

(72) Inventors: Benjamin HATTON, Toronto (CA); Raphael KAY, Toronto (CA); John Alstan JAKUBIEC, Toronto (CA)

(21) Appl. No.: 18/714,048

(22) PCT Filed: Nov. 29, 2022
(86) PCT No.: PCT/CA2022/051747

§ 371 Date: May 28, 2024

Related U.S. Application Data
(60) Provisional application No. 63/283,691, filed on Nov. 29, 2021.

(51) Int. Cl. E06B 3/67; E06B 9/24

(52) U.S. Cl. CPC E06B 3/6722; E06B 9/24; E06B 2009/2411

(57) ABSTRACT

A device for regulating light passing through the device comprises a multi-layered stack. The stack comprises a first layer and a second layer. The first layer and the second layer allow the light to pass through the first layer and the second layer. A first fluid channel is defined between the first layer and the second layer. The first fluid channel allows the light to pass through the first fluid channel. A first fluid is operably received into the first fluid channel and operably withdrawn from the first fluid channel.

### BACKGROUND

### Field

The disclosed subject matter relates to the field of building facades. More particularly, but not exclusively, the subject matter relates to dynamically regulating sunlight passing through building facades.

### Discussion of Related Art

Fundamentally, building facades represent the interface between the indoor and outdoor environment of a building. Building facades have several functions. Among these functions, building facades are designed for regulating transmission of visible light to illuminate the building interior, scattering of visible light to provide even daylighting across a space, and transmission of infrared light to maintain a comfortable indoor thermal condition. Conventional building facades and shading mechanisms, however, are either static or minimally controllable. Many of these conventional minimally controllable mechanisms are expensive or energy-intensive to manufacture, may include toxic materials, may require large energy costs to operate, or may not be amenable to user and digital configurability.

In view of the foregoing, there is a need in the art for improved techniques that require low operational energy, are relatively low cost, are easily and cleanly producible, while being capable of dynamically controlling light transmission.

### SUMMARY

In one aspect, a device is provided for regulating light transmission through the device. The device compromises a multi-layered stack comprising a first layer and a second layer. The first layer and the second layer allow the light to pass through them. A first fluid channel is defined between the first layer and the second layer. The first fluid channel allows the light to pass through it. The first fluid is operably received into the first fluid channel and operably withdrawn from the first fluid channel.

Optionally the device includes a single channel layer and multiple stacking of channel layers

### BRIEF DESCRIPTION OF DRAWINGS

Embodiments are illustrated by way of example and not limitation in the figures of the accompanying drawings, in which like references indicate similar elements and in which:

FIG. 1 is a schematic illustration of a device 100 for regulating light passing through the device, in accordance with an embodiment;

FIG. 2A is a top view of a multi-layered stack 102 of FIG. 1, in accordance with an embodiment;

FIG. 2B is an exploded sectional view of a multi-layered stack 102 of FIG. 2A, in accordance with an embodiment;

FIG. 2C is a section view of the multi-layered stack 102 of FIG. 2A, in which a first fluid is withdrawn out from the first fluid channel and a second fluid is withdrawn out from the second fluid channel, in accordance with an embodiment;

FIG. 2D is a section view of the multi-layered stack 102 of FIG. 2A, in which the first fluid 218 is filled in the first fluid channel 114 and the second fluid is withdrawn out from the second fluid channel, in accordance with an embodiment;

FIG. 2E is a section view of the multi-layered stack 102 of FIG. 2A, in which the first fluid is withdrawn out from the first fluid channel and the second fluid 220 is filled in the second fluid channel 116, in accordance with an embodiment;

FIG. 2F is a section view of the multi-layered stack 102 of FIG. 2A, in which the first fluid 218 is filled in the first fluid channel 114 and the second fluid is filled in the second fluid channel 116, in accordance with an embodiment;

FIG. 2G is a sectional view of another embodiment of the multi-layered stack 102, in which the first fluid channel 114 is present and the second fluid channel is absent, in accordance with an embodiment;

FIGS. 3A and 3B are schematic illustration of the first fluid channel 114 and the second fluid channel 116, in accordance with an embodiment;

FIG. 4A is a section view of the multi-layered stack 102 in which a first set of elongated fluid paths 302a and a second set of elongated fluid paths 302b are parallel to each other, while being offset, in accordance with an embodiment;

FIG. 4B is a schematic representation in which the first set of elongated fluid paths 302a and the second set of elongated fluid paths 302b are at an angle to each other, in accordance with an embodiment;

FIG. 5A illustrates the fluid channels 114 and 116 being formed using a single flexible sheet 208a and 210a, respectively, in accordance with an embodiment;

FIG. 5B illustrates the fluid channels 114 and 116 being formed using a single flexible sheet 208a and 210a, respectively, in accordance with another embodiment;

FIG. 6A illustrates the multiple multi-layered stacks 102 arranged to form a facade 600 of a building, in which the fluids are withdrawn from all the multiple multi-layered stacks 102, in accordance with an embodiment;

FIG. 6B illustrates the facade 600, in which the fluids are introduced into all the multiple multi-layered stacks 102, in accordance with an embodiment;

FIG. 6C illustrates the facade 600, in which the fluids are introduced into some of the multiple multi-layered stacks 102, in accordance with an embodiment;

FIG. 7 is a schematic illustration of another embodiment of the device 700 in which an additional fluid can be selectively introduced in the fluid channels, in accordance with an embodiment; and

FIG. 8 is a block diagram of a control unit 112 of the device 100 and 700, in accordance with an embodiment.

FIGS. 9A and 9B show one embodiment of the invention.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, methods, procedures and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

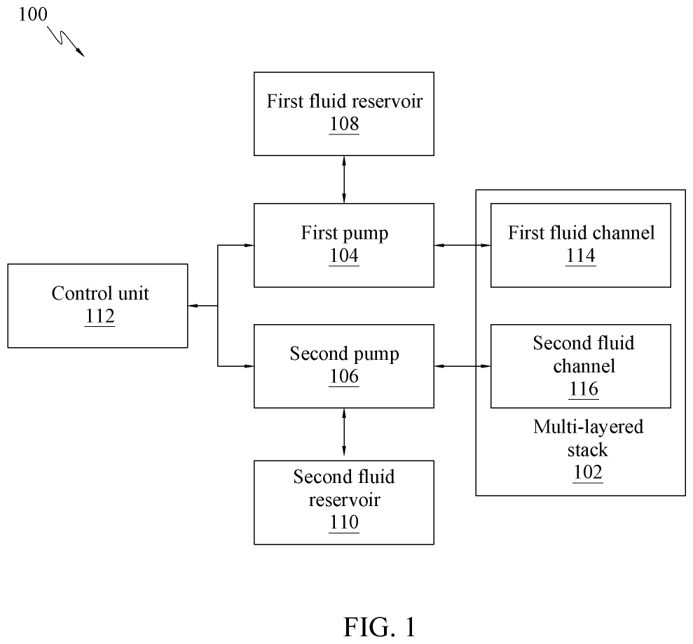

Referring to FIG. 1, a schematic illustration of a device 100 for regulating light passing through the device 100 is provided. The device 100 comprises a multi-layered stack 102, a first pump 104, a second pump 106, a first fluid reservoir 108, a second fluid reservoir 110 and a control unit 112. The multi-layered stack 102 comprises a first fluid channel 114 and a second fluid channel 116. The first fluid channel 114 is connected to the first pump 104, which is connected to the first fluid reservoir 108. The second fluid channel 116 is connected to the second pump 106, which is connected to the second fluid reservoir 110. The first fluid reservoir 108 accommodates a first fluid and the second fluid reservoir 110 accommodates a second fluid. The first pump 104 and the second pump 106 are connected to the control unit 112. The control unit 112 may control the operations of the first pump 104 and the second pump 106.

The first pump 104, as per the instructions from the control unit 112, may fill the first fluid channel 114 with the first fluid by drawing the first fluid from the first fluid reservoir 108. Further, the first pump 104, as per the instructions from the control unit 112, may withdraw the first fluid from the first fluid channel 114 into the first fluid reservoir 108. The extent of filling and withdrawal of the first fluid may also be controlled by the control unit 112.

Likewise, the second pump 106, as per the instructions from the control unit 112, may fill the second fluid channel 116 with the second fluid by drawing the second fluid from the second fluid reservoir 110. Further, the second pump 106, as per the instructions from the control unit 112, may withdraw the second fluid from the second fluid channel 116 into the second fluid reservoir 110. The extent of filling and withdrawal of the second fluid may also be controlled by the control unit 112.

Examples of the first pump 104 and the second pump 106 may include, but are not limited to, digital peristaltic pump (INTLLAB RS385-635) and digital syringe pump (NEW ERA PUMP SYSTEMS, NE-1010).

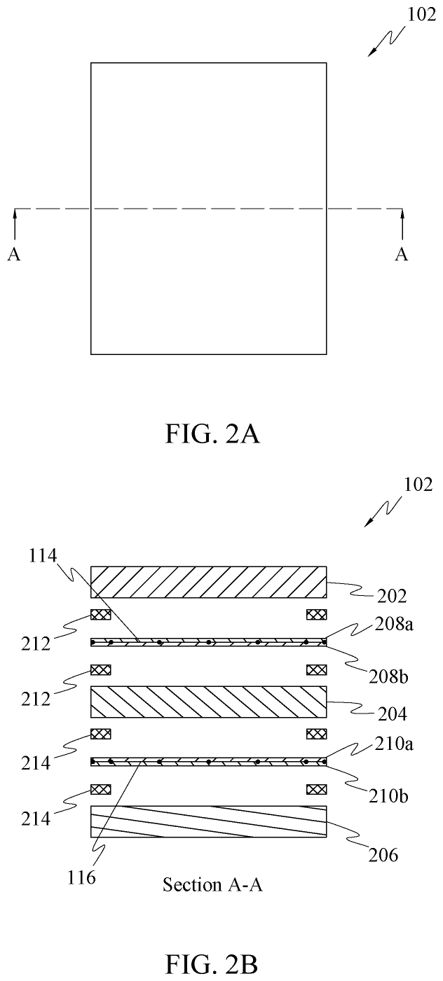

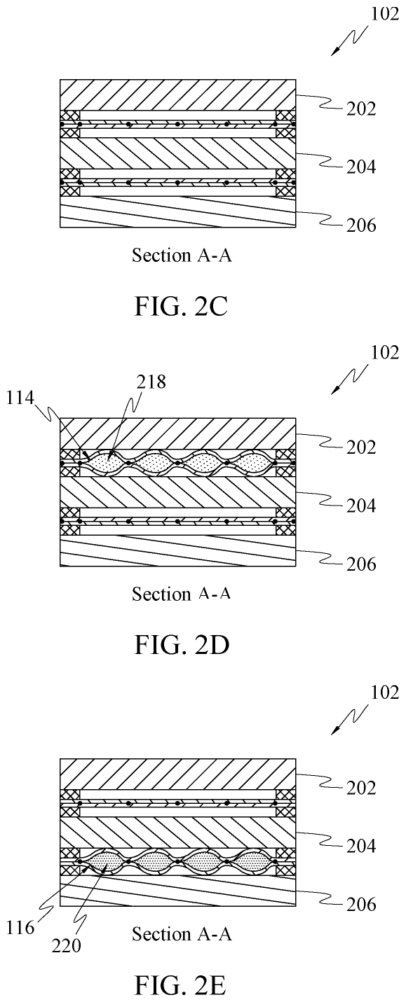

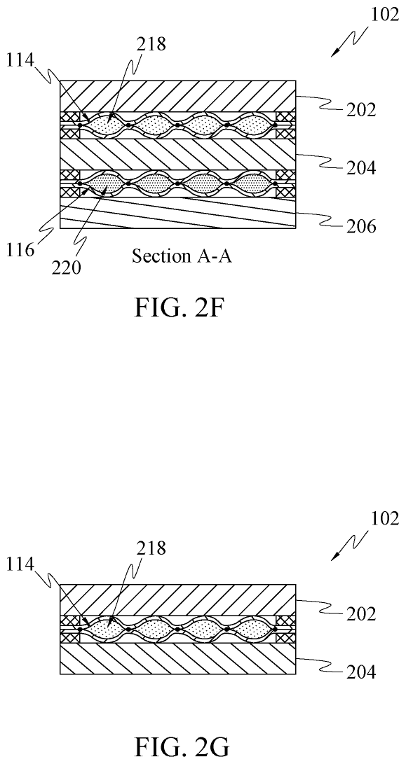

We now move on to discussing the construction of the multi-layered stack 102. Referring particularly to FIGS. 2A to 2F, the multi-layered stack 102 comprises a first layer 202, a second layer 204, a third layer 206, the first fluid channel 114 defined by a first pair of flexible sheets 208a and 208b, the second fluid channel 116 defined by a second pair of flexible sheets 210a and 210b, first spacers 212 and second spacers 214.

The first pair of flexible sheets 208a and 208b are provided between the first layer 202 and the second layer 204. The first spacers 212 are provided between the first layer 202 and the second layer 204 to create a space between the first layer 202 and the second layer 204. The first pair of flexible sheets 208a and 208b may be accommodated in the space created by the first spacers 212 between the first layer 202 and the second layer 204. The space may have sufficient height to allow the first fluid channel 114, defined by the first pair of flexible sheets 208a and 208b, to expand when it is filled by the first fluid 218.

Likewise, the second pair of flexible sheets 210a and 210b are provided between the second latheyer 204 and the third layer 206. The second spacers 214 are provided between the second layer 204 and the third layer 206 to create a space between the second layer 204 and the third layer 206. The second pair of flexible sheets 210a and 210b may be accommodated in the space created by the second spacers 214 between the second layer 204 and the third layer 206. The space may have sufficient height to allow the second fluid channel 116, defined by the second pair of flexible sheets 210a and 210b, to expand when it is filled by the second fluid 220.

Referring specifically to FIGS. 2C-2F, the first fluid 218 may be independently filled into or withdrawn from the first fluid channel 114. The first fluid channel 114 expands upon receiving the first fluid 218, and contracts upon withdrawal of the first fluid 218. Likewise, the second fluid 220 may be independently filled into or withdrawn from the second fluid channel 116. The second fluid channel 116 expands upon receiving the second fluid 220, and contracts upon withdrawal of the second fluid 220. It may be noted that, as is clear from the foregoing, filling and withdrawal of the fluids from the first fluid channel 114 may be controlled independently of the filling and withdrawal of the fluids from the second fluid channel 116.

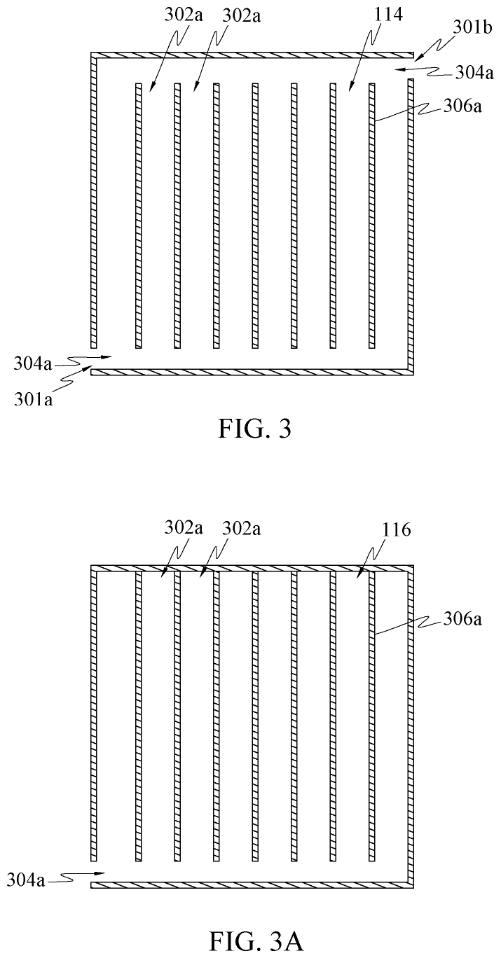

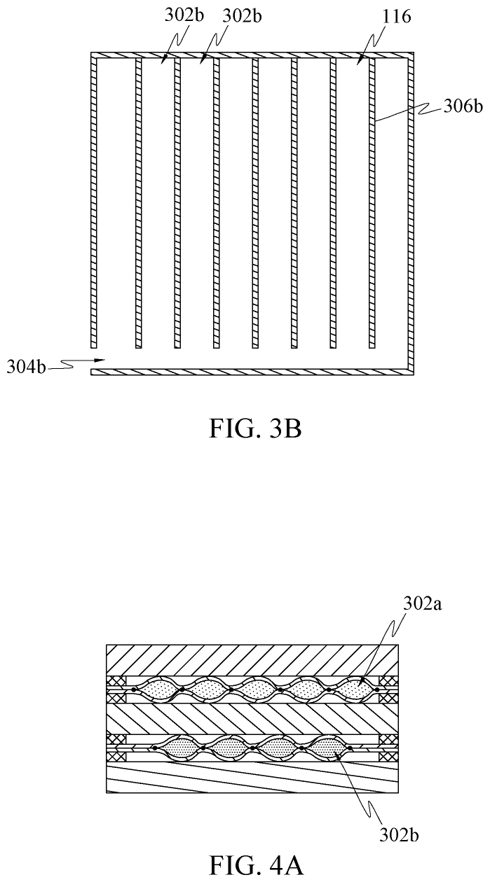

We now move on to discussing the construction of the first fluid channel 114. Referring to FIGS. 2A-2F and FIG. 3, the first pair of flexible sheets 208a and 208b may be sealed together at specific intervals or locations 306a to define the first fluid channel 114 in which the fluid may pass through. Such sealing may be achieved using techniques, such as but are not limited to, thermal heat sealing. The first fluid channel 114 may comprise first set of elongated fluid paths 302a, which are connected to a feeder path 304a. The first fluid 218 may enter the first fluid channel 114 through the inlet 301A of the feeder path 304a and feed the first fluid 218 to the first set of elongated fluid paths 302a. The first fluid 218 may be withdrawn from the first fluid channel 114 through the outlet 301b of the feeder path 304a. In an embodiment, referring to FIG. 3A, the outlet 301b may be absent and the introduction and withdrawal of the first fluid 218 may happen through the inlet of the feeder path 304a.

Referring to FIG. 3B, the constriction of the second fluid channel 116 may be similar to that of the first fluid channel 114. The second fluid channel 116 may likewise comprise a second set of elongated fluid paths 302b, which are connected to a feeder path 304b. The second fluid 220 may enter the second fluid channel 116 through the inlet of the feeder path 304b and feed the second fluid 220 to the second set of elongated fluid paths 302b.

It may be noted that the fluid paths defined by the first fluid path 114 and second fluid path 116 may vary and are not limited to the paths discussed or illustrated in this disclosure.

In an embodiment, as illustrated in FIGS. 2A-2F interpreted in view of FIGS. 3A-3B, the first set of elongated fluid paths 302a and the second set of elongated fluid paths 302b may be parallel to each other and overlap.

Specifically referring to FIG. 2G, only the first fluid channel 114 is provided in the multi-layered stack 102. The first fluid channel 114 is provided between the first layer 202 and the second layer 204.

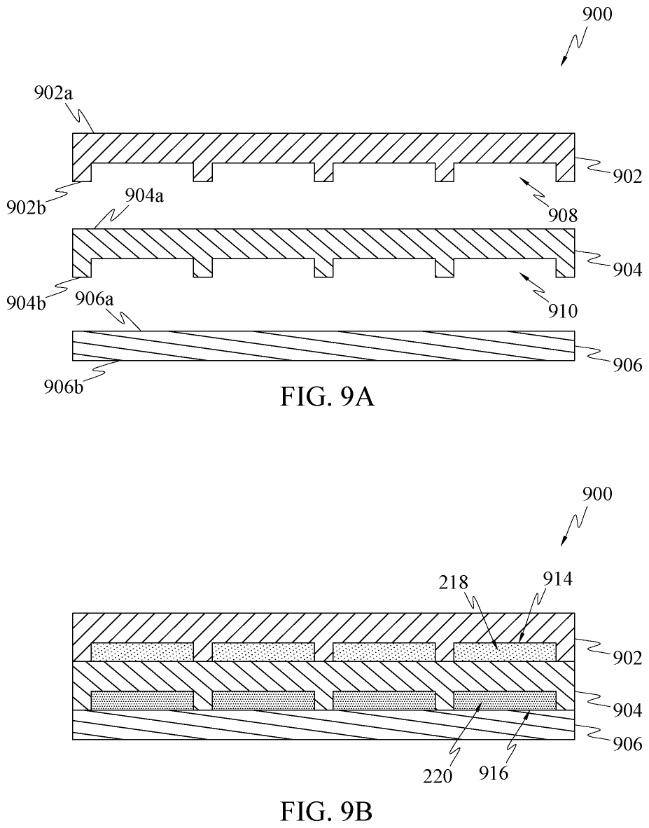

In the foregoing discussion, we have discussed the first fluid channel and the second fluid channel to be formed by flexible sheet(s). Alternatively, the first channel and the second fluid channel may be defined by rigid channels. Referring now to FIGS. 9A-9B, the multi-layered stack 900 comprises a first layer 902, a second layer 904 and a third layer 906. The first layer 902 comprises a first surface 902a and a second surface 902b. The second layer 904 comprises a third surface 904a and a fourth surface 904b. The third layer 906 comprises a fifth surface 906a and a sixth surface 906b. The second surface 902b is provided with a first set of channels 908, wherein the third surface 904a is adhered to the second surface 902b, exposing the third surface 904a to the first set of channels 908, to define the first fluid channel 914. Likewise, the fourth surface 904b of the second layer 904 is provided with a second set of channels 910. The fifth surface 906a is adhered to the fourth surface 904b, exposing the fifth surface 906a to the second set of channels 910, to define the second fluid channel 916. The first fluid 218 may be controllably received and withdrawn from the rigid first fluid channel 914, and the second fluid 220 may be controllably received and withdrawn from the rigid second fluid channel 916.

Examples of material of the first layer 704, the second layer 706 and the third layer 708 include, but are not limited to, polymethyl methacrylate.

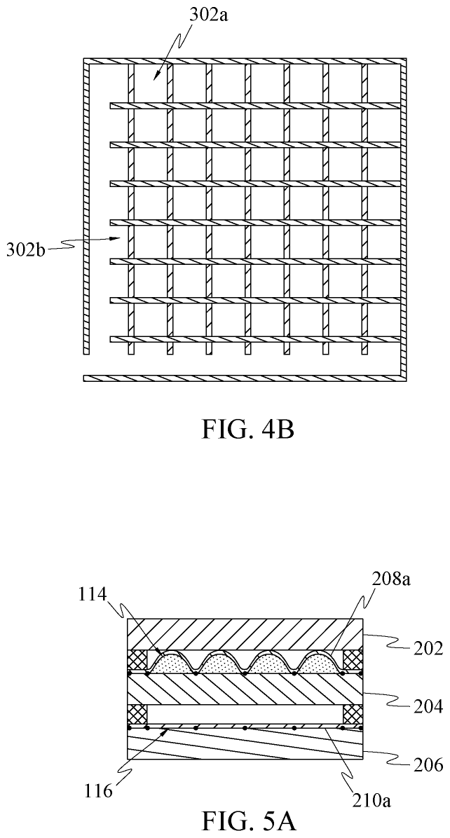

In another embodiment, as illustrated in FIG. 4A, the first set of elongated fluid paths 302a and the second set of elongated fluid paths 302b may be parallel, while the first set of elongated fluid paths 302a are offset from the second set of elongated fluid paths 302b along an axis perpendicular to longitudinal axis of the first set of elongated fluid paths 302a and the second set of elongated fluid paths 302b.

In another embodiment, as illustrated in FIG. 4B, the first set of elongated fluid paths 302a and the second set of elongated fluid paths 302b are at an angle to each other.

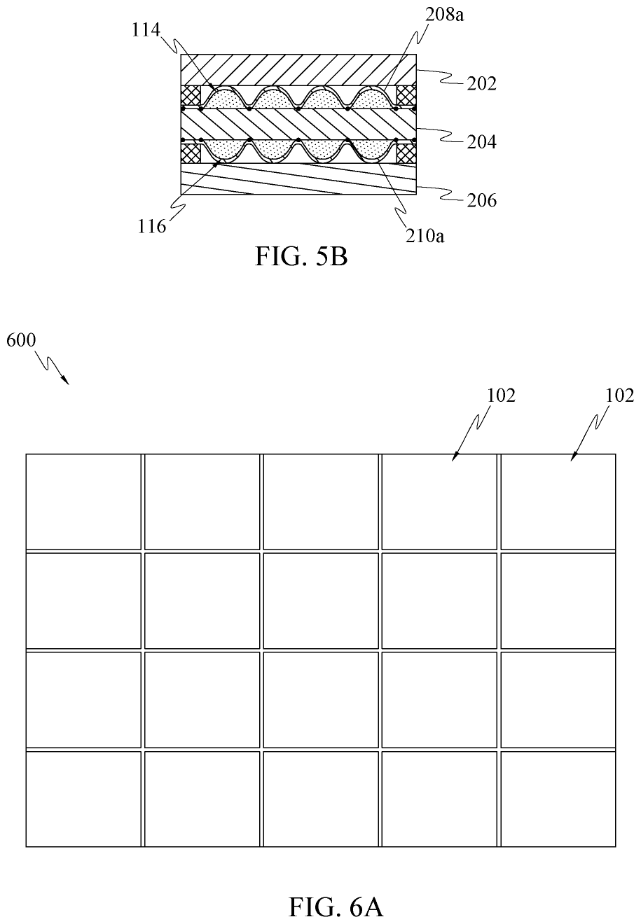

In an embodiment, referring to FIG. 5A, a flexible sheet 208a may be sealed to one of the first layer 202 or the second layer 204 at predefined locations to define the first fluid channel 114, wherein the flexible sheet 208a is sandwiched between the first layer 202 and the second layer 204. Likewise, a flexible sheet 210a may be sealed to one of the second layer 204 or the third layer 206 at predefined locations to define the second fluid channel 116, wherein the flexible sheet 210a is sandwiched between the second layer 204 and the third layer 206.

Alternatively, referring to FIG. 5B, a first flexible sheet 208a and a second flexible sheet 210a may be sealed to the opposite surfaces of the same rigid sheet, such as the second layer 204, to define the first fluid channel 114 and the second fluid channel 116.

In the foregoing, we have discussed using flexible sheet(s) to define fluid channels. Examples of material of the flexible sheets include, but are not limited to, flexible transparent polymer sheets (0.10 mm to 1 mm thick).

Each layer can independently control light absorption, fluorescence, reflection and scattering. The additive combination of these optical effects is what determines the overall light transmission (and reflection) through the window.

Further, in the foregoing, we have discussed the flexible sheets being sandwiched between the rigid first, second and third layers. The rigid layers may be transparent and allow light to pass through them. Examples of material of the rigid layers include, but are not limited to, polyethylene (PE), polystyrene (PS), polymethyl methacrylate (PMMA), polycarbonate (PC), or polyvinylchloride (PVC).

In an embodiment, the first fluid 218 may be different from the second fluid. Examples of the first fluid may include, but are not limited to, air, water, water-based suspensions of nanoparticles including carbon, TiO₂, SiO₂, and gold, oils including silicon oil, and alcohols including ethanol. Examples of the second fluid 220 may include, but are not limited to, air, water, water-based suspensions of nanoparticles including carbon, TiO₂, SiO₂, and gold, oils including silicon oil, and alcohols including ethanol.

It may be noted that, although the disclosure discusses two layers of fluid channels, a single layer of fluid channel or greater than two layers of fluid channels can be achieved by the teachings of the current disclosure.

In an embodiment, different fluid may be used in each of the layer of fluid channels so that different optical properties of the light/sunlight incident on the device may be altered. Such optical properties include, but are not limited to, regulating transmission of visible light to illuminate the building interior, scattering of visible light to provide even daylighting across a space, and selective absorption of near-infrared light to maintain a comfortable indoor thermal condition.

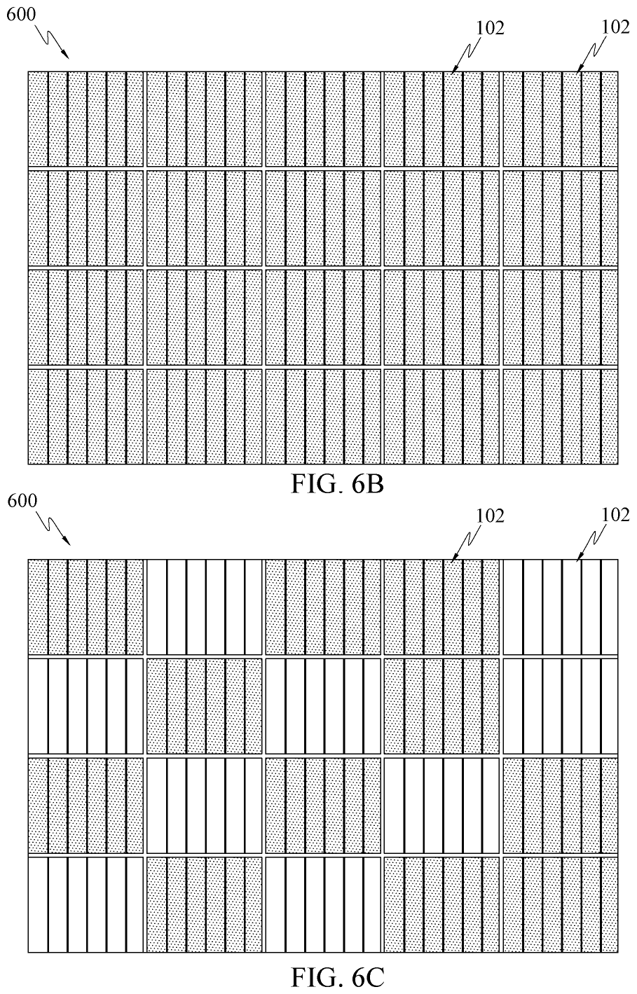

Referring to FIG. 6A-6C, a facade 600 for a building may be formed using a plurality of the devices 100 or multi-layered stacks 102 arranged adjacent to each other. Referring specifically to FIG. 6A, fluids may be withdrawn from all the multi-layered stacks 102, which may allow for relatively high sunlight penetration into the interior of the building through the façade 600. Alternatively, referring to FIGS. 6B and 6C, based on various factors, such as time of the day, the direction of the façade 600 relatively to the sunlight, desired intensity of illumination, desired scattering of the light and desired temperature inside the building, among others, fluid(s) may be introduced into some or all the multi-layered stacks 102.

It may be noted that, as discussed earlier, selectively, the first fluid 218 and the second fluid 220 may be introduced and withdrawn independently from each of the multi-layered stacks 102, thereby enabling control of the characteristics of the sunlight at the level of each multi-layered stack 102.

In an embodiment, groups of multi-layered stacks 102 may share a single first pump 104 and a single second pump 106, which brings down the cost of the façade, while allowing each of the groups to be controlled independently.

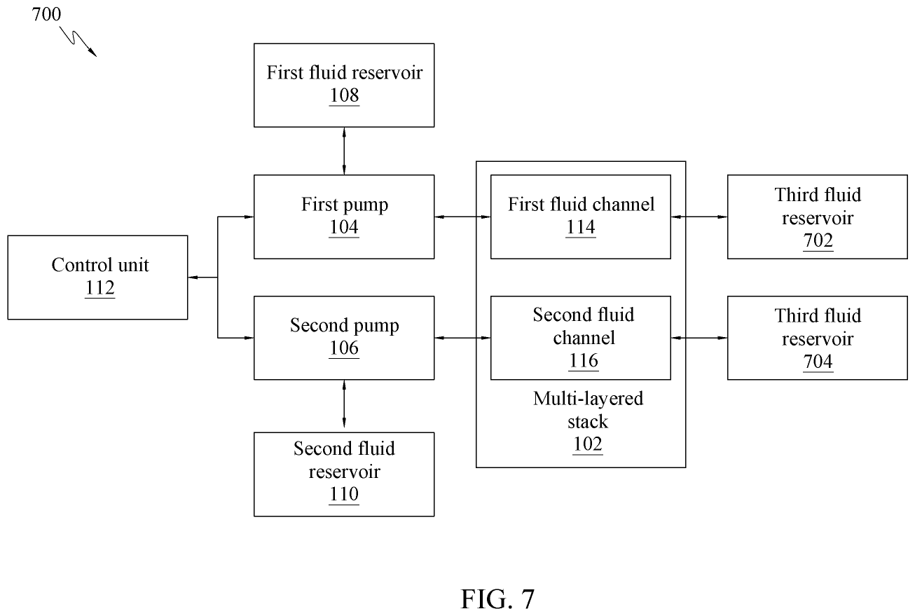

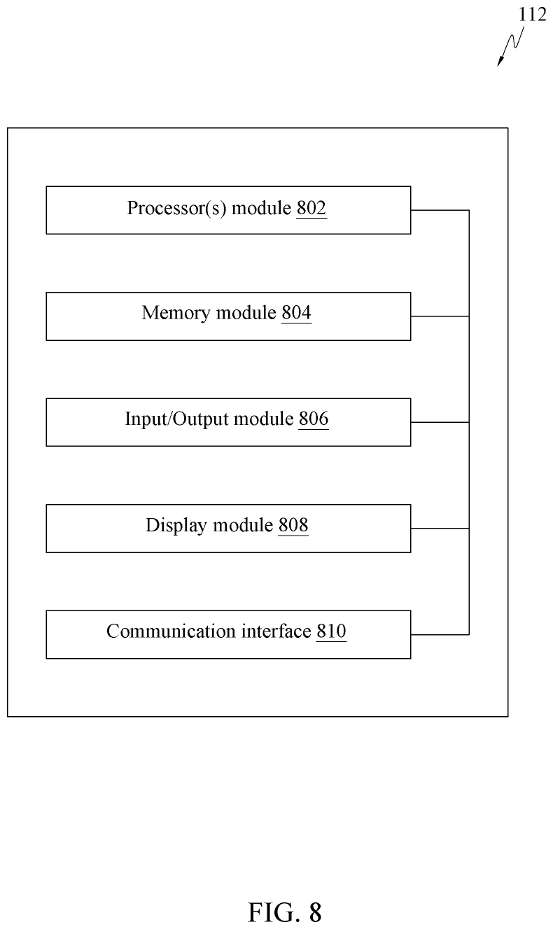

We now move on to discussing another embodiment of the device 700. Referring to FIG. 7, the device 100 comprises third fluid reservoirs 702 and 704. One of the third fluid reservoir 702 may be connected to the first fluid channel 114, and the other third fluid reservoir 704 may be connected to the second fluid channel 116.

A third fluid may be operably received into the first fluid channel 114 and operably withdrawn from the first fluid channel 114. Reception of the first fluid 218 into the first fluid channel 114 displaces the third fluid from the first fluid channel 114. The displaced third fluid is collected in the third fluid reservoir 702. Further, reception of the third fluid into the first fluid channel 114 displaces the first fluid from the first fluid channel 114, wherein the displaced first fluid 218 is collected in the first fluid reservoir 108.

Similarly, the third fluid may be operably received into the second fluid channel 116 and operably withdrawn from the second fluid channel 116. Reception of the second fluid 220 into the second fluid channel 116 displaces the third fluid from the second fluid channel 116. The displaced third fluid is collected in the third fluid reservoir 704. Further, reception of the third fluid into the second fluid channel 116 displaces the second fluid 220 from the second fluid channel 116. The displaced second fluid 220 is collected in the second fluid reservoir 110.

The third fluid may be different from the first fluid. Further, the third fluid may be selected to have a refractive index generally of the same value as refractive index of the first layer, the second layer, and the third layer, wherein the layers may be of the same material.

Examples of the third fluid may include, but are not limited to, mineral oil.

Moving on, as discussed earlier, the flow of the fluids into and out of the multi-layered stack may be controller by a control unit 112. Referring to FIG. 9, the control unit 112 may include processor(s) module 802, a memory module 804, an input/output module 806, a display module 808, a communication interface 810 and a bus 912 interconnecting all the modules of the control unit 112.

The processor(s) module 802 may implemented in the form of one or more processors and may be implemented as appropriate in hardware, computer executable instructions, firmware, or combinations thereof. Computer-executable instruction or firmware implementations of the processor(s) module 802 may include computer-executable or machine-executable instructions written in any suitable programming language to perform the various functions described. The instructions that may enable the functionality of the system 102 may be executed by the processor(s) module 802.

The memory module 804 may include a permanent memory such as hard disk drive, may be configured to store data, and executable program instructions that are implemented by the processor(s) module 802. The memory module 804 may be implemented in the form of a primary and a secondary memory. The memory module 804 may store additional data and program instructions that are loadable and executable on the processor(s) module 802, as well as data generated during the execution of these programs. Further, the memory module 804 may be a volatile memory, such as a random access memory and/or a disk drive, or a non-volatile memory. The memory module 804 may comprise removable memory such as a Compact Flash card, Memory Stick, Smart Media, Multimedia Card, Secure Digital memory, or any other memory storage that exists currently or may exist in the future.

The input/output module 806 may provide an interface for input devices such as sensors, computing devices, keypad, touch screen, mouse, and stylus among other input devices; and output devices such as speakers, printer, and additional displays among others. The input/output module 806 may be used to receive data or send data through the communication interface 810.

The display module 808 may be configured to display content. The display module 808 may also be used to receive input. The display module 808 may be of any display type known in the art, for example, Liquid Crystal Displays (LCD), Light Emitting Diode (LED) Displays, Cathode Ray Tube (CRT) Displays, Orthogonal Liquid Crystal Displays (OLCD) or any other type of display currently existing or which may exist in the future.

The communication interface 810 may include a modem, a network interface card (such as Ethernet card), a communication port, and a Personal Computer Memory Card International Association (PCMCIA) slot, among others. The communication interface 810 may include devices supporting both wired and wireless protocols. Data in the form of electronic, electromagnetic, optical, among other signals may be transferred via the communication interface 810. It may be noted that, the processes described above is described as a sequence of steps, this was done solely for the sake of illustration. Accordingly, it is contemplated that some steps may be added, some steps may be omitted, the order of the steps may be re-arranged, or some steps may be performed simultaneously.

### Additional Embodiments

At the building interface, independent, synergistic control over transmitted light intensity, spectrum, and scattering is necessary to achieve optimized and climate-responsive functions. Control of total light intensity would enable modulation of solar heat gain and illumination; control of spectrum and, in particular, switchable transmission of near-infrared-selective (NIR) sunlight would decouple infrared heating from visible daylighting; while control of scattering would allow for the spatial tuning of transmitted photons within a room. In the current absence of a building material with this combinatorial functionality, interior heating, cooling, and lighting systems must bear the brunt of temperature and illumination control, compensating entirely for exterior environmental fluctuations and interior occupant changes.

To alter this energy-intensive paradigm, buildings would benefit from independent, switchable control over total transmittance, NIR-selective absorption, and scattering by the outer facade. Developing this scalable, combinatorial optical platform, with the ability to separately tune each of these three properties, might be considered the ‘holy grail’ for building material design.

Here, we have developed a large-area fluidic multilayer device, demonstrating independent and additive control of total light transmission, spectrally-selective light absorption, and spatially-directable light dispersion through coordinated digital fluid flows therein. These sequential aqueous fluid layers within a building facade can regulate optimal degrees of total light transmission, NIR light transmission, and visible light scattering in response to fluctuating solar conditions, for significant energy savings in building operation (heating, cooling, and electric lighting energy). These results suggest a new design paradigm for buildings, where confined, switchable fluid layers within a facade can behave in concert as functionally-programmable optical and solar filters.

In these multilayered devices, the overall light transmission (colour and intensity) can be controlled with combinations of dyed solutions, using established, additive colour theory. When two fluid layers overlap, we should expect the transmission spectrum through the bilayer to equal the product of the transmission spectra of the layers independently.

We can achieve a wide range of colour control by activating combinations of aqueous yellow, orange, red, green, and blue dyes. Expected changes to absorption spectra and overall colour were achieved across the device (209 cm2) using only 14 mL of solution (0.067 mL/cm2) within 40 s of channel-filling.

The Beer-Lambert law determines the absorbance (ratio of incident I_0 to transmitted I intensity) through each fluid layer as a function of molar absorptivity E, the layer thickness b, and particle concentration c. The absorbance of these aqueous layers is linearly proportional to the pigment concentration.

Because many liquids are strongly absorbing in the NIR (750-2500 nm), but transparent within the visible (350-750 nm), we suggest that confined fluid flows can achieve selective switchable control over NIR absorption within a window transparent to visible light. We tested a series of fluids and solutions that are transparent (>75%) in the visible but highly-absorbing in the NIR within a bilayer device. Air is transparent across the visible and NIR spectrum (350-2500 nm); glycerol absorbs frequently in the NIR (absorbance peaks at −1200 nm, −1400 nm, and −1700 nm) and completely between 2250-2500 nm; while highly-diluted aqueous carbon black pigment (0.0156 mg carbon/mL) absorbs completely between 1400-2500 nm. When we replace an air layer with this aqueous pigment, for instance, the visible transmission through the device is reduced only mildly (ΔTvis=16%), however the transmitted NIR decreases considerably (ΔTNIR=76%).

The ability to actively modulate the transmission of solar radiation for control over interior light intensity is a crucial function for energy conservation. We injected aqueous suspensions of carbon black pigment (paracrystalline carbon) within a bilayer device to modulate total light transmission. We demonstrated maximum reductions in interior light intensity of 100% when the layers (1.5-mm-deep) were completely filled with carbon suspensions of at least 4 mg/mL. Light transmission within the visible spectrum was spectrally-uniform and, as expected, intensity decreased with particle concentration of shading fluids.

Analogous to organism physiology, treating building ‘skin’ functions individually allows us to curate the optical conditions within a local indoor environment. Like an additive filtration system, the absorption and reflection spectra of incident light can be dynamically tuned through the activation of sequential fluid layers, each with a specific transmission peak or scattering distribution. The use of non-toxic and replenishable aqueous solutions is important, particularly in comparison to technologies such as electrochromic layers, which require semiconductor fabrication techniques, and toxic materials such as indium tin oxide.

Through bottom-up design of chemical composition, the optical properties of confined fluids (solutions or suspensions) are highly tunable in spectral absorption and scattering. Moreover, liquids and gasses are easily ‘transportable’. As a result of this combined functionality, fluid-based systems can perform a wide range of dynamic optical responses that solid-state materials simply cannot achieve. For example, inorganic oxide-based low-emissivity coatings, chalcogenides and redox-active materials can achieve well-defined optical absorption, but either not dynamically or not with independent control of shading, scattering and NIR-selective absorption. We suggest that solution-based organic synthesis and nanoparticle suspension chemistry, alternatively, can accomplish an incredible diversity of selective photonic functions. We envision, for example, that buildings might behave as switchable greenhouses, able to admit visible and NIR sunlight in the day, but, through a directed switching of IR-absorbent liquid, block long-wave IR egress in the night. Switchable fluidic NIR and IR responses might be achieved through bottom-up organic synthesis of selectively-absorbing and luminescent solar concentrator dyes, as well as cholesteric liquid crystalline broadband NIR reflector molecules.

There also exists scope for more advanced photonic engineering, where colloidal nanoparticles can be customized to achieve various degrees of specular reflection and scattering, and the bandgap of quantum dot nanocrystals can be tuned to achieve bespoke absorption and emission. Colloidal suspensions might also be designed as waveguides—typically achieved using absorption and remission, rather than scattering—for building-integrated solar concentration and photovoltaic technologies.

Finally, building surfaces containing chemistries with selective visible absorption spectra might be used to mediate human photobiology. Fluids that selectively filter specific visible wavelengths could be dispersed along the facade to achieve on-demand colour-change in response to occupant circadian dynamics, with demonstrated potential to improve human alertness, comfort, and overall health. This broad optical programmability, from organic synthesis to photonic particle control, would allow engineers, architects, and chemists to collectively design a building's toolkit of functional responses.

Confined fluids can also be tweaked to improve functionality within real building environments. In colder climates, where glazing-integrated fluids might be exposed to temperatures of −20° C., low melting-point liquids (ethanol) can be added to aqueous solutions to avoid freezing. This designed functionality can also be coupled with strategic glazing integration. In the summer, for instance, NIR-absorbing layers are most practical on the exterior of a double pane window, where absorbed NIR sunlight can be predominantly shed to the outdoors. In the winter, however, a NIR-absorbing layer might be beneficial on the interior of a double pane window, where absorbed sunlight can be convectively transferred indoors.

Additionally, this digital control of our dynamic facade is a critical requirement for energy optimization, enabling artificial intelligence for further enhanced building operational efficiency. Deep and reinforcement learning techniques can be used to synthesize large amount of real-time data, better predict occupant and environmental behaviours, and minimize operational energy usage, toward automating a building's multilayered fluidic response. While buildings are becoming increasingly sensory, the capabilities of existing building facades to respond to high-resolution environmental data are limited, and thus limiting. Our optically-reconfigurable system, coupled with internet-of-things (IoT) sensing and data processing technologies, should help advance the smart building paradigm, enabling future generations of buildings to learn.

Fluid Types Contemplated Throughout this Description

Fluids which may be used in the channels include, but are not limited to water, ethylene glycol, alcohols, silicone oils, hydrocarbons, fluorinated oils, organic solvents, ionic liquids and gases (air), solutions of inorganic compounds, organic compounds, nitrogen-containing compounds, oxygen-containing compounds, sulfur-containing compounds, fluorinated compounds, carbonyl compounds, acids, bases, a colloidal suspension of solid particles, wherein the particles are selected from the group including carbon, inorganic materials, metals (Au, Ag), metal oxides (TiO2, SiO2), polymers (polystyrene, polymethylmethacrylate) or organic compounds, semiconductors. In addition, (a) suspensions of upconverting nanoparticles to produce visible light, (b) suspensions of chemical species that absorb UV or visible light and emit infrared light, (c) mid-infrared or near-infrared pigments, suspensions of structural colored materials (e.g., inverse opals), (d) suspensions of colored pigments (e.g., Prussian Blue), (e) suspensions of completely-absorbing materials (e.g., carbon nanotube forests or absorbing materials with a gradient of refractive index), (f) suspensions of quantum dots, (g) suspensions of other nanostructured and microstructure scattering or selectively-reflecting surfaces, (h) suspensions of Bragg stacks, (i) thermochromic/photochromic dyes, (k) suspensions of phase-changing hydrogels/polymers.

### Materials Contemplated

Materials contemplated for the transparent medium include, but are not limited to, glass (SiO2), polymers and plastics; polyvinylchloride, polydimethylsiloxane, polystyrene, polymethylmethacrylate, polycarbonate, polyurethane, or polysulphonate.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

### Sealed-Channel Flexible Layer (SCFL) Fluidic Films

A alternate objective of this invention is to use confined fluids within a window layer device to reversibly and uniformly change optical properties from transparent to some ‘optically-active’ state (such as scattering/cloudy) across a full-scale building window, as illustrated.

We have previously generated ‘milli-fluidic’ layers for active windows based on conventional microfluidic techniques, to engineer (fixed) channels within a PMMA sheet, by CNC machining, or to mould into PDMS silicone.

These ‘rigid channel’ devices have been made by sandwiching two (or more) layers together, to bond a ‘channel’ layer against a flat layer using adhesives or solvent bonding.

There are several problems with this rigid channel design; at least 2 fluids are required (host fluid, and guest fluid) to have a switchable window layer; the pressure required to fill such large areas (long channels) can become significant; and fabrication becomes very difficult at the length scales of full-sized building windows (ie; 2×3 m2 for example), both for the milling and moulding of channels, and the adhesion between large plastic sheets without leaks or misalignment.

In this invention thin, flexible, transparent polymer sheets (0.10 to 1 mm thick) are used to confine fluids within channels patterned by locally ‘welding’ (sealing), using a technique such as thermal heat sealing. The polymer sheets are flexible, allowing the channels to open and close as fluid is introduced or withdrawn, respectively.

As a result, this Sealed Channel Flexible Layer (SCFL) design can allow switching between a transparent state and an optically-active state (ie; shaded, cloudy, NIR-absorbing) using just the introduction or withdrawal of a single fluid, instead of two (or more) fluids.

These flexible channels allow the device to be more simple in operation, scalability, manufacturability and cost, compared to the rigid channel design:
(1) Operation: fewer fluids are necessary, as the ‘transparent’ state can be achieved as a default state for closed (sealed) channels, which means fewer fluids to manage (switching and pumping). Also, the optically-active fluid (shading, scattering, absorbing) can be introduced to the SCFL layer through spontaneous drainage and wetting (with suitable surface tension and viscosity), under gravitational action from a reservoir, instead of active pumping.
(2) Weight: the polymer sheets of the SCFL are much thinner (0.1 to 1.0 mm) than the layers of a rigid channel device (PMMA or PDMS, typically 1 cm thick total).
(3) Scalability and cost: Adhesion of the plastic sheets can be achieved through conventional heat sealing methods, as used in standard plastic film/bag packaging, using rapid impulse sealing for thermoplastics, or patterned adhesive regions. This fabrication method means that arbitrarily long lengths of PVC sheet (for example) can be fed through a channel-sealing process in a semi-continuous process, and layered devices can be made to lengths of >10 m. Also, plastic sheet such as polyethylene (PE), polystyrene (PS) or polyvinylchloride (PVC) is significantly cheaper (around USD$2/m2) than PMMA (around $50/m2) or PDMS silicone (around $100/m2) sheet materials.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

1. A device for regulating light transmission through the device, the device comprising:
a multi-layered stack comprising:
a first layer and a second layer, wherein the first layer and the second layer allow the light to pass through the first layer and the second layer; and
a first fluid channel defined between the first layer and the second layer,
wherein the first fluid channel allows the light to pass through the first fluid channel; and
a first fluid operably received into the first fluid channel and operably withdrawn from the first fluid channel.

2. The device of claim 1, wherein:
the first layer and the second layer are rigid; and
the first fluid channel is flexible, wherein the first fluid channel expands upon receiving the first fluid inside the first fluid channel and contracts upon withdrawal of the first fluid from the first fluid channel.

3. The device of claim 2, further comprising a pair of flexible sheets, wherein the pair of flexible sheets are sealed together at predefined locations to define the first fluid channel, wherein the pair of flexible sheets are sandwiched between the first layer and the second layer.

4. The device of claim 2, further comprising a flexible sheet, wherein the flexible sheet is sealed to one of the first layer or the second layer at predefined locations to define the first fluid channel, wherein the flexible sheet is sandwiched between the first layer and the second layer.

5. The device of claim 1, further comprising:
a third layer forming a part of the multi-layered stack, wherein the third layer allows the light to pass through the third layer;
a second fluid channel defined between the second layer and the third layer, wherein the second fluid channel allows the light to pass through second fluid channel; and
a second fluid operably received into the second fluid channel and operably withdrawn from the second fluid channel, wherein the second fluid is different from the first fluid.

6. The device of claim 5, wherein the first fluid channel comprises a first set of elongated fluid paths and the second fluid channel comprises a second set of elongated fluid paths, wherein the first set of elongated fluid paths and the second set of elongated fluid paths are parallel to each other.

7. The device of claim 6, wherein the first set of elongated fluid paths are offset from the second set of elongated fluid paths along an axis perpendicular to longitudinal axis of the first set of elongated fluid paths and the second set of elongated fluid paths.

8. The device of claim 6, wherein the first set of elongated fluid paths and the second set of elongated fluid paths overlap.

9. (canceled)

10. The device of claim 1, further comprising a third fluid, a first fluid reservoir and a third fluid reservoir, wherein:
the first fluid reservoir and the third fluid reservoir are provided outside the multi-layered stack;
the third fluid is operably received into the first fluid channel and operably withdrawn from the first fluid channel;
the third fluid is different from the first fluid;
reception of the first fluid into the first fluid channel displaces the third fluid from the first fluid channel, wherein the displaced third fluid is collected in the third fluid reservoir; and
reception of the third fluid into the first fluid channel displaces the first fluid from the first fluid channel, wherein the displaced first fluid is collected in the first fluid reservoir.

11. The device of claim 10, wherein the third fluid is selected to have a refractive index generally of the same value as refractive index of the first layer and the second layer, wherein the first layer and the second layer are of the same material.

12. A facade for a building, the facade comprising a plurality of the device of claim 1 arranged adjacent to each other.

13. The facade of claim 12, wherein the facade is configured to receive the first fluid in the first fluid channel in selected some among the plurality of the devices.

14. The facade of claim 12, wherein the devices are configured into a first group of the devices and a second group of the devices, wherein the introduction and withdrawal of the first fluid into and from the first fluid channel of the first group of the devices is independent of the introduction and withdrawal of the first fluid into and from the first fluid channel of the second group of the devices.

15. The device of claim 1, wherein:
the first layer comprises a first surface and a second surface, wherein the second surface is provided with a first set of channels; and
the second layer comprises a third surface and a fourth surface, wherein the third surface is adhered to the second surface, exposing the third surface to the first set of channels, to define the first fluid channel.

16. The device of claim 15, further comprising a second fluid channel, a second fluid and a third layer forming a part of the multi-layered stack, wherein:
the third layer allows the light to pass through the third layer;
the third layer comprises a fifth surface and a sixth surface;
the fourth surface of the second layer is provided with a second set of channels;
fifth surface of the third layer is adhered to the fourth surface of the second layer, exposing the fifth surface to the second set of channels, to define the second fluid channel;
the second fluid is operably received into the second fluid channel and operably withdrawn from the second fluid channel, wherein the second fluid is different from the first fluid.

17. The device of claim 15, further comprising a third fluid, a first fluid reservoir and a third fluid reservoir, wherein:
the first fluid reservoir and the third fluid reservoir are provided outside the multi-layered stack;
the third fluid is operably received into the first fluid channel and operably withdrawn from the first fluid channel;
the third fluid is different from the first fluid;
reception of the first fluid into the first fluid channel displaces the third fluid from the first fluid channel, wherein the displaced third fluid is collected in the third fluid reservoir; and
reception of the third fluid into the first fluid channel displaces the first fluid from the first fluid channel, wherein the displaced first fluid is collected in the first fluid reservoir.

18. The device of claim 17, wherein the third fluid is selected to have a refractive index generally of the same value as refractive index of the first layer and the second layer, wherein the first layer and the second layer are of the same material.

19. A device for regulating light transmission through the device, the device comprising:
a first transparent layer and a second transparent layer, with a plurality of channels defining spaces therebetween allowing a fluid to flow through the spaces;
a first inlet port connected to at least one of the plurality of channels to allow a fluid to flow into the at least one channel; and a first outlet port connected to at least one of the plurality of channels to allow a fluid to flow out through the outlet port;
wherein the transparent layers are flexible and configured to have a first state allowing the plurality of channels to fully close and a second optically-active expanded state upon introduction of the fluid.

20. The device according to claim 16, wherein the channels define a closed-loop fluid circulation system, and further comprising a digital controller for controlling operating parameters.

21. The device according to claim 17, wherein the digital controller permits reversible light transmission from transparent to non-transparent states.
